(19) United States
(12) Patent Application Publication
(10) Pub. No.: US 2014/0115100 A1
(43) Pub. Date: Apr. 24, 2014

(54) VIDEO PACKET SCHEDULING METHOD FOR MULTIMEDIA STREAMING

(71) Applicants: Nesrine Changuel, Nozay (FR); Bessem Sayadi, Nozay (FR); Michel Kieffer, Bourg-la-Reine (FR)

(72) Inventors: Nesrine Changuel, Nozay (FR); Bessem Sayadi, Nozay (FR); Michel Kieffer, Bourg-la-Reine (FR)

(73) Assignee: ALCATEL LUCENT, Paris (FR)

(21) Appl. No.: 13/982,904

(22) PCT Filed: Jan. 4, 2012
(86) PCT No.: PCT/EP2012/050084

§ 371 Date: Dec. 19, 2013

(30) Foreign Application Priority Data
Jan. 31, 2011 (EP) 11290068.3

(51) Int. Cl. H04L 29/06

(52) U.S. Cl. CPC H04L 65/608; H04L 65/607
USPC 709/217

(57) ABSTRACT

A video packets scheduling method for multimedia streaming toward a receiver (7) provided with a video decoder (72), via a transmission chain including an access point (11) and a proxy (3), said proxy (3) provided with post-encoder buffers (31) and with a controller (32), said access point (11) provided with a buffer (4) of lower layer, said method comprising a resolution step of an optimisation problem controlling the state of the buffer (4) in the access point (11) and the state of the post-encoder buffers (31) in the proxy (3).

### FIELD OF THE INVENTION

This invention relates generally to the technical field of multimedia streaming over wired and wireless networks.

### BACKGROUND OF THE INVENTION

Multimedia applications (such as mobile television, video on demand, IPTV, video conference, digital video broadcasting (DVB), audio/video streaming, two-way video telephony, real-time gaming and the like) are as ever gaining popularity and acceptance, especially among mobile users. Such development is mainly due to wireless networks which, extended to the existing wired infrastructure, offer mobility and portability conveniences for the end-user. Hence, a great attention is paid for Quality of Service (QoS) requirements satisfaction with the purpose of an unconditional adoption of multimedia applications.

Nevertheless, multimedia data transmission particularly experiences multiple constrains that severely limit the QoS intended to be offered to end-users. These constrains have mainly to do with several key requirements with regard to the particular nature of multimedia applications when compared to other kind of applications that need to be satisfied so as to provide a reliable and efficient transmission:
easy adaptability to bandwidth variations with regard to the demand for high data transmission rate (bandwidth-consuming applications);
robustness to data loss with regard to the sensitiveness of multimedia applications to packets delays (latency and jitter) and/or the tolerance to packet losses (packet-loss tolerant applications).

Moreover, apart from the bandwidth scarcity due to an increased number of users, multimedia delivery to wireless receivers is particularly challenging
to time-varying characteristics of wireless channels (such as error-rate and bandwidth); and
to delivery delay constraints of some multimedia applications, especially real-time ones such as video conference, two-way video telephony, or mobile television.

To address these problems, various error-control strategies based on the employment of a feedback mechanism, i.e. from the receiver to the source, have been proposed. This feedback mechanism is in charge of conveying information regarding the path characteristics and receiver behavior (estimated at the receiver) to the transmitter (i.e. the source). For doing so, the receiver sends channel quality measurements (the available bandwidth, the status of stream path, the loss rate for example) toward the source. A common technique implementing this feature is to use, for example,
applicative feedbacks (i.e. originating from the application layer) like RTCP messages; or
Medium Access (MAC) layer forward error correction.

Reported network information is then utilized by the source to optimize the transport of multimedia streams (rate adaptation, transcoding, packet drop, frame drop, or layer drop in case of scalable stream) such as a RTCP-based traffic-encoding adjustment at the application layer.

In recent bibliography, different proposals of cross-layer approaches utilizing these feedbacks can be found. These approaches aim to coordinate and optimize, jointly or separately, layers performances by adapting theirs behaviors to constantly varying reported feedbacks.

But on another hand, one can mention that
as it is stated in the RFC, applicative feedbacks occupy a non-negligible part (5%) of the bandwidth that is initially intended to be allocated to multimedia content transmission. Accordingly, feedback messages come compete to share, with the multimedia stream, the already scarce bandwidth;
these feedbacks do not provide immediate information about the status of the stream path, and are usually obtained with a variable delay. For example, when considering unicast applications, various types of feedback from the receiver may be obtained, for example at the application layer via RTCP feedback to get information about the level of buffers at application layer or at MAC layer via HARQ ACK/NACK (S. Sesia, I. Toufik, and M. Baker, LTE, The UMTS Long Term Evolution: From Theory to Practice, chapter 17, February 2009) to get information about the channel conditions. A major problem, here, is that, with such control schemes, feedback comes with delay. This delay may be of the order of tens to hundreds of milliseconds for HARQ ACK/NACK messages to one or several seconds for RTCP packets, which may cause stability problems. Obviously, the presence of this delay is independent from the RTCP mode (immediate feedback mode, early RTCP mode, or regular RTCP mode for example).

A further problem is about the complexity of feedbacks management between a mobile receiver and the source of the multimedia application.

One object of the present invention is to improve end-user QoS in multimedia applications without using feedbacks messages from the receiver.

Another object of the present invention is to ensure reliable transport of multimedia stream using feedback from the MAC layer.

Another object of the present invention is to get rid of the applicative feedbacks (e.g. RTCP).

Another object of the present invention is to estimate the channel condition in a time varying channel without applicative feedbacks.

Another object of the present invention is to effectively use the bandwidth allocated for the transmission, over wired and wireless networks, of a real-time multimedia application.

Another object of the present invention is to enable the derivation of the desired QoS metrics without using applicative feedbacks.

Another object of the present invention is to provide a channel-adaptive source coding and error-control schemes without using applicative feedbacks.

Another object of the present invention is to provide a channel-adaptive source coding and error-control schemes that cope with bandwidth variations and data losses.

Another object of the present invention is to provide improved QoS for multimedia applications over a variety of channel conditions.

Another object of the present invention is to control data-encoding rate without using applicative feedbacks.

Another object of the present invention is to provide a mechanism that can improve the QoS of real-time multimedia applications over wireless networks.

Another object of the present invention is to provide a method targeting at mitigating delay and packet loss ratio during the transmission of multimedia data over wired and/or wireless networks.

### DESCRIPTION OF THE DRAWING

The objects, advantages and other features of the present invention will become more apparent from the following disclosure and claims. The following non-restrictive description of preferred embodiments is given for the purpose of exemplification only with reference to the accompanying drawing in which

FIG. 1 is a block diagram illustrating a functional embodiment; and

FIG. 2 shows illustrative simulation results.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key of critical elements of the invention or to delineate the scope of the invention. Its sole purpose is to present some concepts in a simplified form as a prelude to the more detailed description that is discussed later.

The present invention relates to a video packets scheduling method for multimedia streaming toward a receiver provided with a video decoder, via a transmission chain including an access point and a proxy, said proxy provided with post-encoder buffers and with a controller, said access point provided with a buffer of lower layer, said method comprising a resolution step of an optimisation problem controlling the state of the buffer in the access point and the state of the post-encoder buffers in the proxy.

In accordance with a broad aspect, feedback messages transmitted from the receiver are not considered in the controller for video packets scheduling.

In accordance with another broad aspect, the optimization problem is formulated in the framework of a discrete time Markov Decision Process.

The present invention further relates to a controller for video packets scheduling from post-encoder buffers to a buffer of lower layer in an access point, said video packets to be streamed to a receiver provided with a video decoder, said controller programmed for solving an optimization problem controlling the state of the buffer in the access point and the state of the post-encoder buffers (31) in the proxy.

The present invention further relates to a computer program product adapted to perform the method cited above.

While the invention is susceptible to various modification and alternative forms, specific embodiments thereof have been shown by way of example in the drawings. It should be understood, however, that the description herein of specific embodiments is not intended to limit the invention to the particular forms disclosed.

It may of course be appreciated that in the development of any such actual embodiments, implementation-specific decisions should be made to achieve the developer's specific goal, such as compliance with system-related and business-related constraints. It will be appreciated that such a development effort might be time consuming but may nevertheless be a routine understanding for those or ordinary skill in the art having the benefit of this disclosure.

### DETAILED DESCRIPTION OF ILLUSTRATIVE EMBODIMENTS

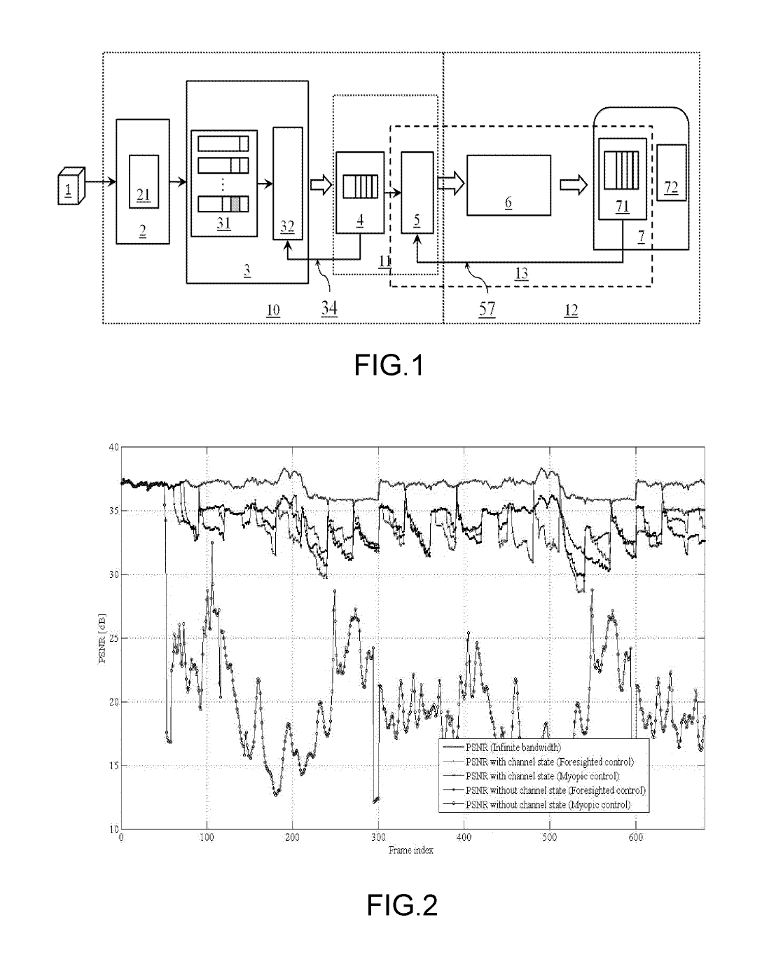

FIG. 1 illustrates the streaming of a video sequence 1 to a mobile (or wireless) station 7 connected to a wireless network 12.

The video sequence 1 may come from different sources such as a storage device, (a database, a multimedia server, a video server for example), or a live camera feed.

The mobile station 7 is any user equipment able to receive and play a multimedia streaming. A smart-phone, a tablet, a computer, a Personal Digital Assistant (PDA), a laptop are non-limitative examples of such mobile station 7.

The wireless network 12 may be a wireless IP network, a Wireless Personal Area Network, a Wireless Local Area Network, a Wireless Metropolitan Area Network, a Wireless Wide Area Networks, or more generally any Mobile devices network which may result from the combination of more than one wireless network.

More generally, the video sequence 1 is routed to the mobile station 7 via a wired network 10 that includes
a streaming server 2 provided with a scalable video encoder 21 (a Fine Granularity Scalability (FSG) coding or an Advanced Video Coding AVC for example);
a proxy 3, generally located at the edge of the wired network 10; and
an access point 11 (i.e. a base station which may be designated differently depending on the deployed communication technology such as Node B for 3G, or eNode-B for LTE), generally co-located with the proxy 3.

Within the streaming server 2, the video sequence 1 is segmented into frames encoded into
a base layer and a set of L−1 enhancement layers, in case of H264 SVC; and
intra and inter frames in case of H264 AVC.

Persons skilled in the art will readily realize that, in case of H264 AVC wherein there are two kinds of inter-frames (predicted frame, commonly denoted P, and the Bi predicted frame, commonly denoted B), the number of L is equal to 2. Further, H264 AVC may be seen as a particular case of H264 SVC wherein the used scalability is the temporal scalability. Accordingly, hereafter and for the sake of generality, the notation of L, and the term of H264 SVC are used.

In the case of a H.264 SVC scalability scheme, Access Units (AU) are the basic processing units, macroblock(s), slices, or frame(s), consisting of the base layer and its corresponding enhancement layers.

Encoding parameters (quantization steps, frame rate and the likes) are controlled by the streaming server 2, independently of the remainder of the transmission chain. Each scalable layer of each encoded frame is packetized (for example into RTP, UDP, or IP packets), then are delivered via an over-provisioned core network 10 to L post-encoder buffers 31 (one per layer) situated in the proxy 3. The controller 32 performs layer filtering within the proxy 3: for each layer, packets may be sent, kept, or dropped.

Sent packets are fed to the MAC buffer 4 (or more generally to a buffer 4 of lower layer) in the access point 11 after being segmented into Packet Data Units (PDUs). PDUs are then transmitted to the mobile station 7, which stores correctly received PDUs in its own MAC buffer 71. Packet de-encapsulation and buffering in one of the L buffers 71 at application layer of the mobile station 7 are done as soon as all corresponding PDUs have been received. Complete or incomplete AUs are then processed by the video decoder 72 of the mobile station 7. Outdated packets are dropped, without being decoded.

Among the components of the access point 11, a particular attention is paid to its MAC (or lower layer) buffer 4. Then to make it apparent, the remainder components of this access point 11 (the MAC scheduler 5, the physical layer, the radio front-end for example) are assumed to be belonging to the channel 13. This channel 13 further comprises the wireless channel 6, the physical layer of the mobile station 7, and the MAC buffer 71 (i.e. the MAC layer managing ACK/NACK procedures) of the mobile station 7.

The MAC buffer 4 of the access point 11 sends feedback (link 34 on FIG. 1) its buffer states to the controller 32 of the proxy 3.

Based on only the reported feedbacks from the MAC buffer 4 of the access point 11, a scalable layer filtering process, operated by the controller 32 of the proxy 3, is designed in such a way that
the overflow of the MAC buffer 4 is avoided, in order to prevent PDUs from being dropped;
the underflow of the MAC buffer 4 is also avoided so as to use the channel in an optimal and efficient way;
the overflow of the post-encoder buffers 31 is avoided to limit the delay introduced by the system;
the underflow of the post-encoder buffers 31 is also avoided, especially at the base layer, since this indicates that too much importance has been given to the base layer compared to the other layers.

Accordingly, without any additional observation on the channel 13 state, the controller 32 has to perform a scalable layer filtering (noting that some scalability layers may be dropped) using only observations made on the MAC buffer 4. Alternatively or in combination, other observation points, instead of MAC buffer 4, such as RLC buffer or PDPC buffer may be adopted.

In other words, by observing only the evolution of fullness of the last buffer in the path before the wireless channel 12, namely the MAC buffer 4, it is possible for the controller 32 of the proxy 3 to decide on which packet/layer to transmit. That is to say, the controller 3 performs a video packet scheduling algorithm without RTCP feedback messages from the wireless station 7 to the proxy 3. Only feedback provided by the ACK/NACK may be exploited to derive the state of the channel (link 57 on FIG. 1).

These above items are achieved through the resolution of an optimisation problem formulated in the framework of a discrete-time Markov Decision Process (MDP).

Thus, the design of an efficient layer filtering process is translated in the framework of discrete-time MDP (R. S Sutton and A. G Barto, Reinforcement Learning: An Introduction, MIT Press, 1998). In fact, an MDP of 4-tuple (S,A,P,R) is defined, and wherein
S is the set of states of the system;
A is the set of actions;
P(s,s′,α) is the transition probability from S(S at time t, to S′(S at time t+1, when the action α(A is applied to the system; and
R(s,s′,α) indicates the immediate reward (or expected immediate reward) received after a transition from s to s′ obtained by using the action α.

Some policy ((s) (A, s(S maximizing the immediate reward (myopic policy) or a discounted sum of future rewards (foresighted policy) has then to be found.

The state of the controlled system consists of gathering
the levels sₘ^{l}, l=, . . . , L of the post-encoder buffers 31;
sₘ corresponding to the level of the MAC buffer 4 in the base station 11; and
h representing the channel state.

The state of the system is thus s=(sₗ^{e},s^{m},h).

The channel is modeled by a first-order Markov process with n states, with known transition probability p(hₜ₊₁|hₜ) and stationary probability p(hₜ). hₜ can represent for example the rate available during the considered time slot. Tow hypotheses concerning the knowledge of the state of the channel are considered:
Hyp.1: instantaneous channel state, where ht is assumed available when choosing the action to apply between time t and t+1; this is realistic only when feedback with very short delay is possible;
Hyp.2: unknown channel state which is a scenario where no channel state feedback is considered.

With regard to action α, the proxy 3 may, and time t, send, hold, or drop packets for each layer l. The action αₗ(l,t)(A taken for the l^{th} layer between time t and t+1 represents the number of transmitted packets from the post-encoder buffer 31 to the MAC buffer 4 (when α_{l,t}>0), or the number of dropped packets (when α_{l,t}<0). If α_{l,t}=0, packets are kept in the post-encoder buffer 31. The vector gathering all actions is α=(β1, . . . , αL) (AL.

Once all states S and actions A have been identified, one has to determine the transition probability matrix P(s,s′,α). To that end, two cases are distinguished as follows:
case 1 (Hyp.1): the channel state hₜ is available to the controller 32 when applying the action α in state s at time t. The state transition matrix is then

P1(sₜ,sₜ₊₁,αₜ)=Pr(sₜ₊₁^{e},s^{m},hₜ₊₁|sₜ^{e},s^{m},hₜ,αₜ) (1)
which may be easily evaluated using the fact that p(hₜ₊₁″hₜ) is known. sₜ^{e} is the vector of all post encoder buffer 31 states, and αₜ is the vector of all action
case 2 (Hyp.1): no channel state ht is available to the controller 32. The state transition matrix may then be written as

$$P 1 ( {s}_{t} , {s}_{t + 1} , {a}_{t} ) = Pr ( {s}_{t + 1}^{e} , {s}^{m} \vert {s}_{t}^{e} , {s}^{m} , {a}_{t} ) = {\sum }_{{h}_{t}}^{ } [ {\sum }_{{h}_{t + 1}}^{ } Pr ( {s}_{t + 1}^{e} ] , {s}^{m} , {h}_{t + 1} \vert {s}_{t}^{e} , {s}^{m} , {h}_{t} , {a}_{t} ) \cdot Pr ( {h}_{t} ) \qquad ( 2 )$$

since sₜ^{e} (vector of all post encoder buffers 31), sₜ^{m}, or αₜ (vector of all action) do not provide additional information on hₜ.

In order to limit the size of these transition matrices P1(sₜ,sₜ₊₁,αₜ), can quantize the values that may be taken by the states S in a more or less coarse way to get a compromise between complexity and description accuracy.

Concerning the reward function R(s,s′,α) at time t, the layer filtering process (i.e. the scheduling algorithm), performed by the controller 31, chooses an action that maximizes the QoS (notably, the video quality) at the receiver side (i.e. at the mobile station 7). To that end, the average Peak Signal to Noise Ratio (PSNR) of the decoded frames is maximized.

In order to avoid the variability of the delay between the time at which an AU is filtered and the time at which it is displayed, an alternative reward function R(s,s′,α), that penalize dropped packets, as well as buffer overflow and underflow according to the system constraints, is built. This reward function is expressed as follows:

$${R}_{t} ( {s}_{t} , {s}_{t + 1} , {a}_{t} ) = E [ {\sum }_{l = 1}^{L} {γ}_{l} {a}_{l , t} + {\sum }_{l = 1}^{L} {α}_{l} {ρ}_{1} ( {s}_{l , t + 1}^{e} , {a}_{l , t} ) + {βρ}_{2} ( {s}_{t + 1}^{m} , {a}_{l , t} ) ] \qquad ( 3 )$$

Where E[.] denotes the expectation function.

The positive parameters γ₁, α₁, and β₁, with l=1 . . . L, trade off the importance of the various constraints. The reward function (3) involves several parts; the first linked to the number of transmitted SNR layers, the others to the post-encoder buffers 31 and the MAC buffer 4 constraints. The reward function (3) is function of the state of the post-encoder-buffers 31 and the state of the MAC buffer 4.

Assuming that increasing the amount of transmitted packets increases the received quality, the transmission reward should help to maximize the amount of transmitted packets.

The parameters γ₁ allow giving a higher priority to packets belonging to the base layer compared to those of the enhancement layers. For post-encoder buffers 31 and MAC buffer 4 constraints, ρ1(.) and ρ2(.) provide positive rewards for satisfying buffer states and negative rewards for states that should be avoided.

The policy π, as a mapping from joint states to joint actions in the considered system, indicates the number of scalable layers to transmit, knowing the state of the post-encoder buffers 31 and of the MAC buffer 4.

The optimal foresighted policy consists in finding the optimal stationary Markov policy π* corresponding to the optimal state-value function defined as

$${V}^{*} ( {s}_{t} ) {max}_{a {\sum }_{k = 0}^{∞} [ {α}^{k} {R}_{t + k + 1} \vert {s}_{t}} ] \qquad ( 4 )$$

where 0<α<1 is the discount factor, which defines the relative importance of present and future rewards. The optimal foresighted policy may be obtained by value or policy iteration algorithms (R. S Sutton and A. G Barto, Reinforcement Learning: An Introduction, MIT Press, 1998). The value in (4) is updated and iterated for all states s until it converges with the left-hand side equal to the right-hand side (which is the Bellman equation for this problem). When α=0 , one gets a myopic policy, maximizing only the immediate reward.

Accordingly, the proposed algorithm controls the level of buffers 4 at MAC (link 34 on FIG. 1) and at Application layers (link 57 on FIG. 1) at the transmitter side only of a communication chain. Feedback at MAC layer is implicitly used, but no applicative feedback (i.e. at the application layer) from the mobile user is considered, avoiding the use of delayed measurements.

The proposed algorithm performs packet scheduling and jointly buffer management in both Application and MAC layers at the transmitter side according to a cross-layer control mechanism.

The controller 32 retrieves information concerning the MAC buffer 4, solves the above MDP optimization problem, and then derives updated operational parameters for the physical and application layers.

The use of the optimized parameters permits to
maximize the number of transmitted layers of the video content 1;
avoid underflow and overflow state in the MAC buffer 4;
avoid underflow and overflow state in the post encoder buffers 71;
consider the buffer fullness at a frame packet level; and consequently
achieve reliable communication, and maximise the QoS at the mobile station 7 side.

Accordingly, the proposed method permits to
increase the spectral efficiency of the uplink channel in the wireless network (no applicative feedback);
filter packet in a blind way, no need to have an applicative feedback,
improve the quality of service of the end-user;
maintain a certain playback margin to the end-user by prioritizing the base layers/packets.

The proposed method is a scheduling algorithm for AVC or SVC video streaming in order to have a quality aware adaptive and selective frame/packet transmission.

The performance of the proposed layer filtering process has been evaluated on several video sequences.

FIG. 2 shows the Peak Signal-to-Noise Ratio (PSNR) behavior versus time for simulation with and without adaptation by controller 32. Video quality is then measured in terms of PSNR to estimate the streaming performance in terms of adaptation gain.

As illustration of the gain achievable with the disclosed method, FIG. 2 reports the results obtained for the video sequence “Foreman.Qcif” at 30 fps. The H.264 SVC encoder is using L=3 SNR scalability layers per frame.

Five curves are plotted on FIG. 2. These curves represent, respectively from the bottom to the top of the FIG. 2, the evolution (in dB) over time (Frame index) of PSNR without channel state (Myopic control), of PSNR without channel state (Foresighted control), of PSNR with channel state (Myopic control), of PSNR with channel state (Foresighted control), and of PSNR with infinite bandwidth.

The settings used in this illustrative example are:
the cumulated average rates (and PSNR for luminance) are

$$74.7 \frac{kbits}{s} ( 32.3 dB )$$

### for Layer 1;

$$165.0 \frac{kbits}{s} ( 34.7 dB )$$

### for Layer 1 and 2; and

$$327.0 \frac{kbits}{s} ( 36.82 dB )$$

for all layers.
the wireless channel is modelled as a 2-state Markov model (n=2): Good state hₜ=1 and bad state hₜ=0. The channel rates are

$$Rc = 240 \frac{Kbit}{s} .$$

The channel state transition probabilities are p11=0.9 and p00=0.8, resulting in an average channel rate of

$$190 \frac{kbits}{s} .$$

Four possible actions per layer are considered at each time instant A={−1,0,1,2}
to minimize complexity, the levels of all buffers are quantized into three possible values: 1 representing underflow, 2 for a satisfying level, and 3 for overflow;
the post-encoder buffers 31 are assumed to have a maximum size (in term of number of packets) Se=55; the over and underflow levels are Seₘₐₓ=50 and Seₘᵢₙ=10. For the MAC buffer 4, a maximum size of Sm=220 equal size PDU of 200 bits each corresponding to a maximum size of 44 bits, and the levels at which it is considered in underflow and overflow are Smₘᵢₙ=10 Kb and Smₘₐₓ=25 kbits;
the values of the parameters in the reward function (equation 3), have been set to reflect the importance of the various constraints: γ_{1,2,a}={150,60,15}, λ_{1,2,a}{100,40,10} and β=300.

Known average source and encoder characteristics have been considered, leading to known average packet lengths in each layers.

In the two considered above cases, the evolution of the PSNR of the decoded sequence obtained with a myopic policy (α=0) and that with a foresighted policy (α=0.9) are represented in FIG. 2.

When the applicative feedback is used, an average gain of about 1.5 dB is obtained with the foresighted policy compared to the myopic one. This gain is mainly due to more packets of the first enhancement layer reaching the receiver.

In the case of the using no applicative feedback (the target of the embodiment), with the myopic policy, about 46% of the time, the MAC buffer 4 is in the overflow state exceeding some time the maximum buffer size. This situation results in the loss of some PDUs which induces a notable decrease of the received video quality. With the foresighted policy, the MAC buffer is in overflow state for about 25% of the time but never loses PDU packets.

Without applicative feedback and using the foresighted policy results in a loss of 0.5 dB in PSNR compared to the case of deploying an applicative feedback strategy. The availability of the state of the MAC buffer 4 provides thus a reasonable estimate of the state of the channel, allowing a satisfying regulation of the received video quality.

Accordingly, the maximum PSNR is obtained when the disclosed method is introduced, and particularly, in this example, for frames after the 50^{th}.

It is noteworthy to mention that the above described method addresses conventional codecs, known for the skilled person in the art, such as H264 AVC, H264/SVC, any further version of them, or any equivalent codec.

The above-described method fits well to multimedia streaming over wireless networks due to frequent channel changes that lead to considerably reduced packet loss rates, especially under heavy traffic conditions.

Others QoS features (IntServ/DiffServ for example) and congestion control mechanisms, especially designed for multimedia data transmission in wired networks, may be combined with the herein described method.

1. A video packets scheduling method for multimedia streaming toward a receiver provided with a video decoder, via a transmission chain including an access point and a proxy, said proxy provided with post-encoder buffers and with a controller, said access point provided with a buffer of lower layer, said method comprising a resolution of an optimisation problem controlling the state of the buffer in the access point and the state of the post-encoder buffers in the proxy.

2. The method of claim 1, wherein no feedback messages are transmitted from the video decoder of the receiver to the controller.

3. The method of claim 1, wherein the optimization problem is formulated in the framework of a discrete time Markov Decision Process.

4. The method of claim 3, wherein the reward function of the Markov decision Process system is as follows:
$${R}_{t} ( {s}_{t} , {s}_{t + 1} , {a}_{t} ) = E [ {\sum }_{l = 1}^{L} {γ}_{l} {a}_{l , t} + {\sum }_{l = 1}^{L} {α}_{l} {ρ}_{1} ( {s}_{l , t + 1}^{e} , {a}_{l , t} ) + {βρ}_{2} ( {s}_{t + 1}^{m} , {a}_{l , t} ) ]$$
E[.] denoting the expectation function, the positive parameters γ₁, α₁, and β₁, with l=1 . . . L, trading off the importance of the various constraints relative to buffer in the access point and to post-encoder buffers in the proxy.

5. A controller for video packets scheduling from post-encoder buffers to a buffer of lower layer in an access point, said video packets to be streamed to a receiver provided with a video decoder, said controller programmed for solving an optimization problem controlling the state of the buffer in the access point and the state of the post-encoder buffers in the proxy.

6. The controller of claim 5, wherein no feedback messages are transmitted from the video decoder of the receiver to the controller.

7. The controller of claim 5, wherein the optimization problem is formulated in the framework of a discrete time Markov Decision Process.

8. The controller of claim 7, wherein the reward function of the Markov decision Process system is as follows:
$${R}_{t} ( {s}_{t} , {s}_{t + 1} , {a}_{t} ) = E [ {\sum }_{l = 1}^{L} {γ}_{l} {a}_{l , t} + {\sum }_{l = 1}^{L} {α}_{l} {ρ}_{1} ( {s}_{l , t + 1}^{e} , {a}_{l , t} ) + {βρ}_{2} ( {s}_{t + 1}^{m} , {a}_{l , t} ) ]$$
E[.] denoting the expectation function, the positive parameters γ₁, α₁, and β₁, with l=1 . . . L, trading off the importance of the various constraints relative to buffer in the access point and to post-encoder buffers in the proxy.

9. A computer program including instructions stored on a memory of a computer and/or a dedicated system, wherein said computer program is adapted to perform the method as claimed in claim 1.
